(19) United States
(12) Patent Application Publication
(10) Pub. No.: US 2026/0104511 A1
(43) Pub. Date: Apr. 16, 2026

(54) POSITIONING SYSTEM AND METHOD FOR GOLF COURSE

(71) Applicant: Yu-Chuan CHANG, Taipei City (TW)

(72) Inventor: Yu-Chuan CHANG, Taipei City (TW)

(21) Appl. No.: 18/914,177

(22) Filed: Oct. 13, 2024

(51) Int. Cl. G01S 19/07; G01S 19/19; G01S 19/43

(52) U.S. Cl. CPC G01S 19/07; G01S 19/19; G01S 19/43

(57) ABSTRACT

The present disclosure relates to a positioning system and method of a golf course. The positioning system includes at least one RTK user device and at least one central base station. The at least one RTK user device is movably installed on the golf course. The at least one central base station is fixed on the golf course and provided for a RTK connection with the at least one RTK user device. The at least one central base station has a GNSS RTK module, at the least one central base station is capable of generating, transmitting and broadcasting RTCM corrections signals and RTK's ability to correct signals, and the at least one RTK user device has a GNSS RTK RX module corresponding to the GNSS RTK module.

### TECHNICAL FIELD

The present disclosure relates to a positioning system and method, and more particularly relates to a positioning system and method for golf course.

### BACKGROUND OF THE DISCLOSURE

The use of conventional GPS golf equipment is too expensive, so the real-time kinematic (RTK) cannot be popularized in the golf field. In addition, the conventional GPS golf equipment retrieves information from existing maps, and the positioning obtained by this method may have an error range of more than 10 m, thus resulting in a very high error value. Furthermore, the conventional golf laser equipment is limited by the physical properties of lasers and can only measure distance in a straight line. It is also restricted by terrains and objects on land, and the positioning error of the laser is between 100 and 200 cm, which is still difficult to achieve a considerable degree of positioning accuracy.

In view of this problems, how to provide a positioning system and positioning method for golf course to improve the positioning accuracy demands immediate attention and feasible solutions.

### SUMMARY OF THE DISCLOSURE

It is a primary objective of the present disclosure to overcome the deficiencies of the related art by disclosing an embodiment of a positioning system for golf course, which includes at least one RTK user device and at least one central base station. The at least one RTK user device is movably installed in a golf course. The at least one central base station is fixed on the golf course and provided for a RTK connection with the at least one RTK user device. Wherein, the at least one central base station has a GNSS RTK module, at the least one central base station is capable of generating, transmitting and broadcasting RTCM corrections signals and RTK's ability to correct signals, and the at least one RTK user device has a GNSS RTK RX module corresponding to the GNSS RTK module.

To achieve the aforementioned objective, the present disclosure provides a positioning system for golf course, which has at least one RTK user device and at least one central base station with a plurality of satellite navigation systems, wherein the satellite navigation systems include Global Positioning System (GPS), Global Navigation Satellite System (GLONASS), BeiDou Satellite Navigation System (BDS), Galileo Positioning System (GALILEO) and Quasi-Zenith Satellite Navigation System (QZSS).

To achieve the aforementioned objective, the present disclosure provides a positioning system for golf course, wherein the signal transmission between the at least one RTK user device and the at least one central base station has a first signal transmission frequency, and a first distance is defined between the at least one RTK user device and the at least one central base station, and the first transmission frequency is inversely proportional to the first distance.

To achieve the aforementioned objective, the present disclosure provides a positioning system for golf course, wherein the at least one RTK user device includes a plurality of RTK user devices, and the signal transmission between the plurality of RTK user devices has a second signal transmission frequency, and a second distance is defined between the plurality of RTK user devices, and the second transmission frequency is inversely proportional to the second distance.

To achieve the aforementioned objective, the present disclosure provides a positioning system for golf course, wherein the at least one RTK user device equipped with RTCM correction signal receiving function, may include a LoRa or other transmission centralizer/collector, a Bluetooth microcontroller, a screen, a barometric pressure sensor, an inertial measurement unit or a compass/gyrocompass.

To achieve the aforementioned objective, the present disclosure provides a positioning system for golf course, wherein the at least one RTK user device is a golf GPS watch or a golf GPS rangefinder.

To achieve the aforementioned objective, the present disclosure provides a positioning system for golf course, wherein the at least one RTK user device is mounted on a golf cart.

To achieve the aforementioned objective, the present disclosure provides a positioning system for golf course, wherein the at least one RTK user device is a smart pin fixed onto a flagstick.

To achieve the aforementioned objective, the present disclosure provides a positioning system for golf course, wherein the smart pin includes a NEMA-6 industrial grade enclosure with a cable sealing sleeve, a GNSS RTK module, an inertial measurement (6-axis) module, a LoRa or other transmission centralizer/collector, a barometric pressure sensor and a high capacity battery.

To achieve the aforementioned objective, the present disclosure provides a positioning system for golf course, wherein the smart pin further includes a solar panel.

To achieve the aforementioned objective, the present disclosure provides a positioning system for golf course, wherein the at least one central base station includes a NEMA-6 industrial grade enclosure with a cable sealing sleeve, a network surge protector, a multi-channel (16 channels) dual-mode LoRa transceiver, a backhaul network and a database.

To achieve the aforementioned objective, the present disclosure provides a positioning system for golf course, wherein the backhaul network of the at least one central base station includes Wi-Fi, 4G LTE, 5G and Ethernet.

In another embodiment of the present disclosure, its primary objective is to provide a positioning method for golf course, which includes the steps of: providing at least one RTK user device, and turning on the at least one RTK user device to transmit a plurality of RTK location information signals; providing at least one central base station, for automatically receiving the plurality of RTK location information signals transmitted by the at least one RTK user device; sending a plurality of location information correction signals from the at least one central base station to the at least one RTK user device; and decoding the plurality of location information correction signals by the at least one RTK user device, and returning a plurality of location information to the at least one central base station after confirming the plurality of location information correction signals.

To achieve the aforementioned objective, the present disclosure provides a positioning method for golf course, wherein the location information includes three-axis (X/Y/Z) location information.

### BRIEF DESCRIPTION OF THE DRAWINGS

FIG. 1 is a schematic view of a positioning system for golf course in accordance with a first embodiment of the present disclosure;

FIG. 2 is a schematic view of a positioning system for golf course in accordance with a second embodiment of the present disclosure;

FIG. 3 is a schematic view of a RTK user device in a positioning system for golf course in accordance with the present disclosure;

FIG. 4 is a schematic view of a central base station in a positioning system for golf course in accordance with the present disclosure;

FIG. 5 is a flow chart of a positioning method for golf course in accordance with the present disclosure; and FIG. 6 is a schematic view showing the use of a smart pin in a positioning system for golf course in accordance with the present disclosure.

### DETAILED DESCRIPTION OF THE PREFERRED EMBODIMENTS

The present disclosure will now be described in more detail hereinafter with reference to the accompanying drawings that show various embodiments of the disclosure, in which the drawings here are intended for the illustrative purpose to assist in the description only, and may not necessarily be the true proportion and precise configuration of the present disclosure after implementation. Therefore, the proportions and configurations of the attached drawings should not be used to limit the scope of the present disclosure

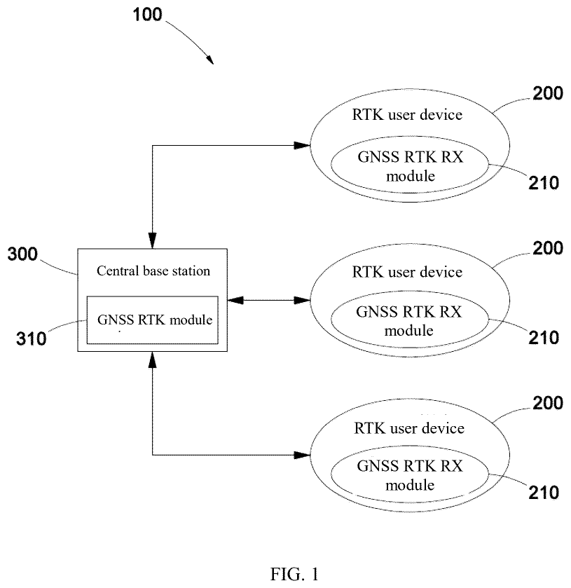

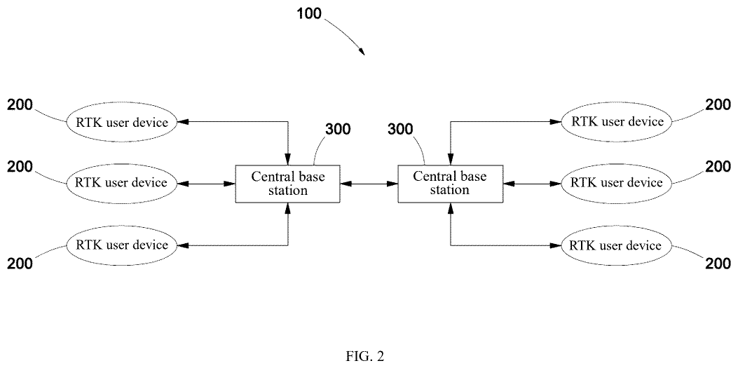

The present disclosure is based on real-time kinematic (RTK) and positioning system to construct a central base station with RTK and Lo Ra functions. By the RTK connection through the central base station to receive the location information returned by the RTK, the effect of obtaining the information on topographic features and location positioning of the entire golf course can be achieved. The present disclosure provides a positioning system for golf course 100 includes at least one RTK user device 200 and at least one central base station 300. In the first embodiment as shown in FIG. 1, the quantity of RTK user devices 200 is 3, and the quantity of central base stations 300 is 1. In the second embodiment as shown in FIG. 2, the quantity of RTK user devices 200 is 6, and the quantity of central base stations 300 is 2.

The RTK user device 200 is movably installed in a golf course; in other words, the RTK user device 200 is not always set at the same location on the golf course. The central base station 300 is fixed on the golf course; in other words, the central base station 300 is arranged at a fixed location on the golf course and preferred arranged at a commanding height on the golf course. In this way, the central base station 300 can be used for the RTK connection with the RTK user device 200. Wherein, the central base station 300 includes a GNSS RTK module 310, central base station 300 is capable of generating, transmitting and broadcasting RTCM corrections signals and RTK's ability to correct signals, and the RTK user device 200 includes a GNSS RTK RX module 210 corresponding to the GNSS RTK module 310, so as to accomplish the RTK connection through the cooperation between the GNSS RTK RX module 210 and the GNSS RTK module 310.

The overall system of the present disclosure is constructed by a high-performance dual-band GNSS RTK module and an industrial grade LoRaWAN gateway to achieve the centimeter-level positioning accuracy and provide a positioning effect within the golf course area, and its accuracy can reach a centimeter level (smaller than 50 cm). Therefore, the positioning effect of the present disclosure includes the distance measurement of a golfer (or an electronic caddy), and the distance measurement of major parts of the golf course, including tees, fairways, rough, greens, bunkers, ponds, trees and vegetation, obstructions, flagsticks, fairway markers, alternative teeing areas, driving lanes, etc., to implement GIS management and asset control and management in a golf course.

In a preferred embodiment, the positioning system for golf course 100 has a RTK user device 200 and the central base station 300 has a plurality of satellite navigation systems including Global Positioning System (GPS), Global Navigation Satellite System (GLONASS), BeiDou Satellite Navigation System (BDS), Gailieo Positioning System (GALILEO) and Quasi-Zenith Satellite Navigation System (QZSS), so as to achieve the positioning with an accuracy up to the centimeter level, but this is not a limitation.

The signal transmission between the RTK user device 200 and the central base station 300 in the positioning system for golf course 100 of the present disclosure has a first signal transmission frequency F1, and a first distance D1 is defined between the RTK user device 200 and the central base station 300, and the first signal transmission frequency F1 is inversely proportional to the first distance D1. In other words, the present disclosure can determine the first signal transmission frequency F1 of the signal transmission between the RTK user device 200 and the central base station 300 by the first distance D1. For example, when the golfer's RTK user device 200 is getting closer to the central base station 300 (i.e. the first distance D1 gradually decreases), the accuracy of the relatively shorter distance can be ensured by increasing the first signal transmission frequency F1; conversely, when the first distance D1 gradually increases, the first signal transmission frequency F1 can be reduced.

When the at least one RTK user device 200 of the positioning system for golf course 100 includes a plurality of RTK user devices 200, the signal transmission between the plurality of RTK user devices 200 has a second signal transmission frequency F2, and a second distance D2 is defined between the plurality of RTK user devices 200, and the second signal transmission frequency F2 is inversely proportional to the second distance D2. In other words, the present disclosure can determine the transmission frequency between the plurality of RTK user devices 200 by distance. For example, when a golfer's RTK user device 200 is getting closer to a RTK user device 200′ at a hole (i.e. the second distance D2 gradually decreases), the accuracy of the relatively shorter distance can be ensured by increasing the second transmission frequency F2; conversely, when the second distance D2 gradually increases, the second signal transmission frequency F2 can be reduced.

With the configuration above, the present disclosure can achieve a positioning effect at a centimeter level (smaller than 50 cm) with lower power consumption by an optimized power management mechanism between different communication protocols. In other words, under normal circumstances, the RTK user device 200 can transmit location information 5 to 6 times per second, and the first signal transmission frequency F1 and the second signal transmission frequency F2 can increase or decrease relatively can be increased or decreased as the first distance D1 and the second distance D2 decrease or increase. In this way, a single RTK user device 200 can maintain a battery life of at least 18 hours under the RTCM communication protocol.

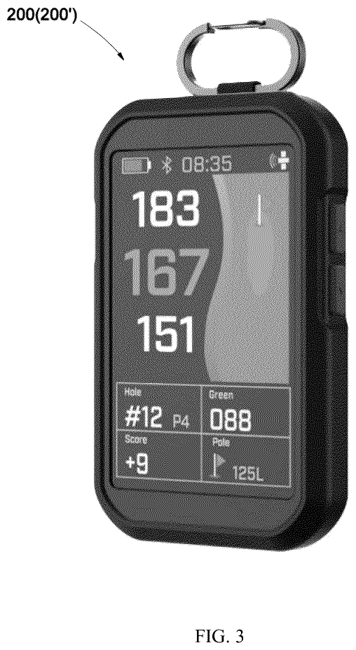

In FIG. 3, the RTK user device 200 in the positioning system for golf course 100 of the present disclosure transmits the location information several times per second (wherein the number of times of transmission is adjustable), which is provided for the central base station 300 to position its own location. The core hardware of the RTK user device 200 is comprised of a high-performance dual-band GNSS RTK module and an industrial grade LoRaWAN gateway, and the RTK user device 200 includes a satellite navigation system (with the function of receiving information of GPS, GLONASS, BDS, GALILEO and QZSS, and the function s of RTK, LoRa, etc.) capable of providing environment information of the golf course, and providing golfers other LBS service integration and expansion capabilities.

The RTK user device 200 may be a device in various different forms to match the characteristics or uses of positioning points, including: a golf GPS watch (which is a RTK user device provided for golfers to carry and use), a golf GPS rangefinder (which is a RTK user device provided for golf course managers or golfers to locate holes, tees, fairways, rough, greens, bunkers, ponds, trees and vegetation, obstructions, flagsticks, fairway markers, alternative teeing areas, driving lanes and other major parts).

The RTK user device 200 equipped with RTCM correction signal receiving function, may include the following components and modules: a GNSS RTK RX module including a highly accurate GNSS antenna, a LoRa (LoRawan or LoRa RF) or other transmission centralizer/collector, a microcontroller (MCU) with Bluetooth (BLE), a screen, a barometric pressure sensor, an inertial measurement unit (IMU) and a compass/gyrocompass, etc., but this is not a limitation.

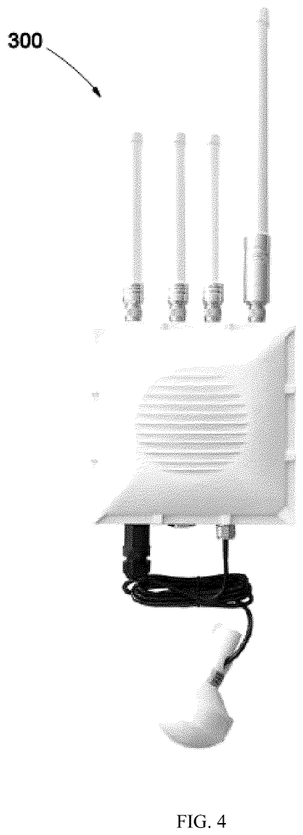

In FIG. 4, the central base station 300 of the positioning system for golf course 100 of the present disclosure is used as the most accurate RTK positioning point on the golf course, including a satellite navigation system (with the function of simultaneously receiving information from GPS, GLONASS, BDS, GALILEO and QZSS). After being placed for a period of time (about 2-3 hours), it will provide an accuracy up to the centimeter level and serve as a location information calibration reference point and information provider for other RTK user devices 200. In addition, the central base station 300 has wireless transmission and connectivity (through the implementation of LoRa), and the connection range can reach 5-6 km, so as to serve as a base station and a database on the golf course to continuously receive location information sent back by the RTK user device 200.

The central base station 300 may include the following components and modules: a NEMA-6 industrial grade enclosure with a cable sealing sleeve, a GNSS RTK module, a network surge protector (PoE+Surge Protection), a multi-channel (16 channels) dual-mode LoRa (LoRawan and LoRa RF) transceiver, a backhaul network including Wi-Fi, 4G LTE, 5G, Ethernet, and database, etc., but this is not a limitation.

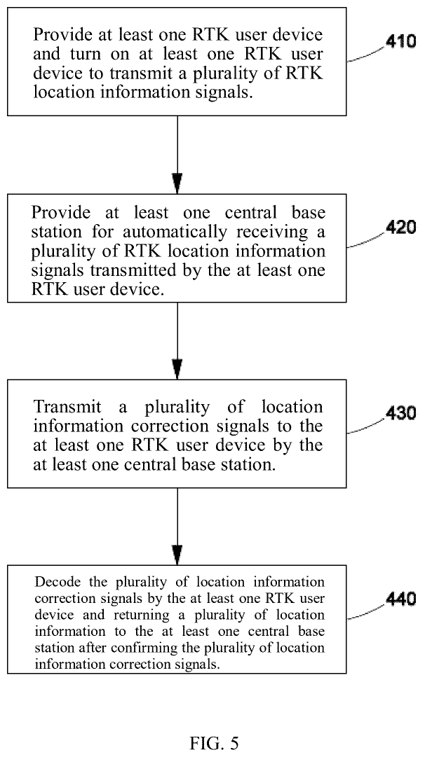

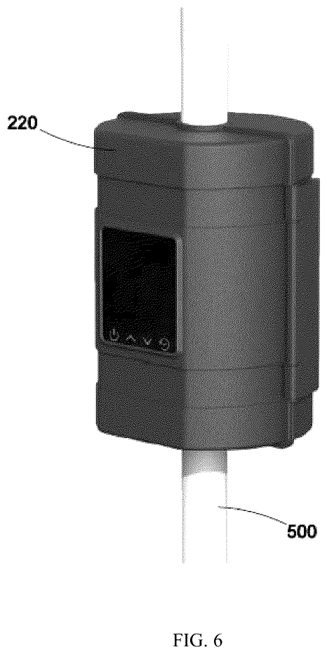

In FIG. 5, the present disclosure further provides a positioning method for golf course, which includes the steps (S410 to S440) as follows: S410: Provide at least one RTK user device 200, and turn on at least one RTK user device 200 to transmit a plurality of RTK location information signals. S420: Provide at least one central base station 300 for automatically receiving a plurality of RTK location information signals transmitted by the at least one RTK user device 200. S430: Send a plurality of location information correction signals to the at least one RTK user device 200 by the at least one central base station 300. S440: Decode the plurality of location information correction signals by the at least one RTK user device 200, and return a plurality of location information to the at least one central base station 300 after confirming the plurality of location information correction signals.

Through the aforementioned positioning method, the present disclosure can locate the RTK user device 200 between the golfer and the hole to obtain the distance between the golfer and the hole, and at the same time achieve a centimeter level (smaller than 50 cm) positioning effect, so that the golfer can obtain accurate relative distance information more easily.

The plurality of location information includes three-axis (X/Y/Z) location information, and the information can be displayed as the three-axis information in 3D software.

The present disclosure may have the following extended applications:

### 1. Various Fields of Application

After the RTK user device 200 of the present disclosure is introduced into a golf course, the RTK user device 200 can be mounted on a golf cart (caddy), e-caddy, etc., to carry out a two-way message push with the central base station 300 of the present disclosure. In addition, after the present disclosure is introduced into a private or public golf court, a positioning service rental of the RTK user device 200 for the golfers can be provided, and corresponding suggestions (including, golf club usage suggestions, etc.) for the distance between the golfer and the hole can be provided in real time.

### 2. Device Scalability

Components, modules, protocols or functions can be added or deleted in the central base station 300 and the RTK user device 200 of the present disclosure or peripheral devices can be added, to meet the use requirements.

Embodiments are described below:

Hardware Scalability: Central control screen is connected, and all RTK user devices 200 and their positioning information are integrated and displayed on the central control screen, realizing GIS management and asset control/management on the golf course.

Software Scalability: Positioning SDKs and APIs for multiple protocols are added to provide customized development or integration of golf-related applications.

### 3. Smart Pin

A type of the RTK user device 200 of the present disclosure is a smart pin 220, which can be applied to hole positioning and has a satellite navigation system (including GPS, GLONASS, BDS, GALILEO and QZSS), RTK, LoRa and other functions. In FIG. 6, the smart pin 220 can be fixed on the flagstick of the hole. When the hole is re-dug to change its position, it does not need to be manually measured again. The new hole position information can be automatically sent back to the central base station 300 of the present disclosure for the update of the location information on the central side, and a solar panel can be optionally equipped to extend the battery life.

The smart pin 220 includes the following components and modules: a NEMA-6 industrial grade enclosure with a cable sealing sleeve, including a GNSS RTK module of an highly accurate GNSS antenna, and inertial measurement (6-axis) module, a LoRa (LoRawan or LoRa RF) or other transmission centralizer/collector, a barometric pressure sensor, a high capacity battery of 15000 mAh or a high capacity battery with more than 180 days of battery life.

In addition, the smart pin 220 can also increase the battery life by adding a solar panel.

### 4. Golf Course Control

Same as the device scalability of the present disclosure described above, it can realize the field control effect of centralized management of all golf course personnel, and can provide the effects of making arrangement for playing golf and scheduling the golf course accordingly. For example, if a golfer's RTK user device 200 stays at a certain position for too long, which means that the golfer plays the golf slowly at a certain hole, the RTK user device 200 of other golfers can be directly notified through the central base station 300, instructing them to go to other holes to continue playing golf.

### 5. Golf Course Depiction

The RTK user device 200 of the present disclosure has a high positioning accuracy. By using the device, a person can carry the RTK user device 200 to mark the major parts of the golf course, including tees, fairways, rough, greens, bunkers, ponds, trees and vegetation, obstructions, flagsticks, fairway markers, alternative teeing areas, driving lanes, etc., to complete the description of the entire golf course, thereby establishing terrain information.

### 6. Small Time to First Fix (TTFF) Value

The typical time to first fix (TTFF) of the RTK user device 200 of the present disclosure is smaller than 45 seconds.

In summation of the description above, the present disclosure overcomes the problems of GPS and laser devices in the prior art and related-art GPS, and the disclosure is implemented by integrating the LoRa transmission technology and the RTK user device 200 with a central base station 300, and has an exclusive RTK algorithm mechanism with advantages such as the positioning mechanism and the optimized power management mechanism, thereby optimizing the battery life and the positioning accuracy.

The aforementioned technical details ensure that the present disclosure has the advantages over the related art as below:

According to the prior art and related art, it is very difficult to directly add RTK, because the prerequisite of RTK is to have a central base station. Therefore, using existing devices, such as mobile phones and their frequency bands or antennas, it is impossible to implement accurate positioning as in the present disclosure.

The prior art and related art do not provide a way to receive RTK correction values, and it is difficult to make changes using existing devices.

With the centimeter level (smaller than 50 cm) positioning accuracy, golfers can obtain more accurate relative distance information with a very small error range compared to the conventional technologies.

The present disclosure adopts LoRa to transmit information, and has a transmission effect within 5˜6 Km, which is sufficient for the use in a general golf course (generally, transmissions within 2 km will be required). However, in other embodiments, the aforementioned LoRa transmission information can also be replaced by other transmission information. Transmission protocols (such as RF, etc.) are not restricted here.

There are also other additional advantages as follows:

The RTK user device 200 of the present disclosure has the capability of providing golf course environment information and other LBS service integration expansion capabilities, which can make golfers willing to carry the RTK user device 200, and allow the central base station 300 to track the dynamic information of the golfer through the RTK user device 200. On the other hand, traditional golf equipment has no attraction for golfers, so most golfers do not like to carry such equipment.

Both the central base station 300 and the RTK user device 200 of the present disclosure have the function of simultaneously receiving information from the satellite navigation systems including GPS, GLONASS, BDS, GALILEO and QZSS to ensure the positioning accuracy even in harsh environments.

The above embodiments are only to illustrate the technical ideas and characteristics of the present disclosure, which are intended to enable those having ordinary skill in the art to understand the contents of the present disclosure and implement them accordingly, and it is to be understood that there is no intent to limit the disclosure to those embodiments. On the contrary, the aim is to cover all modifications, alternatives and equivalent falling within the spirit and scope of the disclosure as defined by the appended claims.

What is claimed is:

1. A positioning system for golf course, comprising:
at least one RTK user device, movably installed in a golf course; and
at least one central base station, fixed on the golf course, and provided for a RTK connection with the at least one RTK user device;
wherein, the at least one central base station comprises a GNSS RTK module, at the least one central base station is capable of generating, transmitting and broadcasting RTCM corrections signals and RTK's ability to correct signals, and the at least one RTK user device comprises a GNSS RTK RX module corresponding to the GNSS RTK module.

2. The positioning system for golf course according to claim 1, wherein the at least one RTK user device and the at least one central base station comprise a plurality of satellite navigation systems including GPS, GLONASS, BDS, GALILEO and QZSS.

3. The positioning system for golf course according to claim 1, wherein the signal transmission between the at least one RTK user device and the at least one central base station has a first transmission frequency, a first distance is defined between the at least one RTK user device and the at least one central base station, and the first transmission frequency is inversely proportional to the first distance.

4. The positioning system for golf course according to claim 1, wherein the at least one RTK user device includes a plurality of RTK user devices, the signal transmission between the plurality of RTK user devices has a second signal transmission, a second distance is defined between the plurality of RTK user devices, and the second signal transmission is inversely proportional to the second distance.

5. The positioning system for golf course according to claim 1, wherein the at least one RTK user device equipped with RTCM correction signal receiving function, comprises a LoRa centralizer/collector, a Bluetooth microcontroller, a screen, a barometric pressure sensor, an inertial measurement unit or a compass/gyrocompass.

6. The positioning system for golf course according to claim 5, wherein the at least one RTK user device is a golf GPS watch or a golf GPS rangefinder.

7. The positioning system for golf course according to claim 5, wherein the at least one RTK user device is mounted on a golf cart.

8. The positioning system for golf course according to claim 5, wherein the at least one RTK user device is a smart pin fixed onto a flagstick.

9. The positioning system for golf course according to claim 8, wherein the smart pin comprises a NEMA-6 industrial grade enclosure with a cable sealing sleeve, a GNSS RTK module, an inertial measurement (6-axis) module, a LoRa centralizer/collector, a barometric pressure sensor and a high capacity battery.

10. The positioning system for golf course according to claim 9, wherein the smart pin further comprises a solar panel.

11. The positioning system for golf course according to claim 1, wherein the at least one central base station comprises a NEMA-6 industrial grade enclosure with a cable sealing sleeve, a network surge protector, a multi-channel (16 channels) dual-mode LoRa transceiver, a backhaul network and a database.

12. The positioning system for golf course according to claim 11, wherein the backhaul network comprises Wi-Fi, 4G LTE, 5G and Ethernet.

13. A positioning method for golf course, comprising the steps of:
providing at least one RTK user device, and turning on the at least one RTK user device to transmit a plurality of RTK location information signals;
providing at least one central base station, for automatically receiving the plurality of RTK location information signals transmitted by the at least one RTK user device;
sending a plurality of location information correction signals to the at least one RTK user device by the at least one central base station; and
decoding the plurality of location information correction signals by the at least one RTK user device, and returning a plurality of location information to the at least one central base station after confirming the plurality of location information correction signals.

14. The positioning method for golf course according to claim 13, wherein the plurality of location information includes a three-axis (X/Y/Z) location information.
